(19) United States
(12) Patent Application Publication
(10) Pub. No.: US 2024/0142332 A1
(43) Pub. Date: May 2, 2024

(54) System And Method For Detecting Pressure Loss Rate And Associated Events For Motor Vehicle Tires

(71) Applicants: Bridgestone Corporation, Chuo-ku (JP); Bridgestone Americas Tire Operations, LLC, Nashville, TN (US)

(72) Inventors: Toshiki Kuramoto, Shinjyuku-ku (JP); Teppei Mori, Saitama-shi (JP); Haruya Ishizuka, Kunitachi-si (JP); Meagan Gentry, Raleigh, NC (US); Maxfield H. Thompson, Franklin, TN (US); Hansie Rivera, Franklin, TN (US); Philip Wade, Nashville, TN (US)

(21) Appl. No.: 18/271,873

(22) PCT Filed: Dec. 16, 2021
(86) PCT No.: PCT/US2021/072954

§ 371 Date: Jul. 12, 2023

Related U.S. Application Data
(60) Provisional application No. 63/137,929, filed on Jan. 15, 2021.

(51) Int. Cl. G01M 3/26; B60C 23/04; G01M 17/02

(52) U.S. Cl. CPC G01M 3/26; B60C 23/0476; B60C 23/0477; G01M 17/02

(57) ABSTRACT

Systems and methods are disclosed herein for tire condition monitoring, and more particularly for detecting slow leakage of inflation pressure. Data acquisition devices (e.g., tire pressure monitoring system sensors) are mounted onboard motor vehicles and collect data samples corresponding to at least tire inflation pressure. The collected data samples may e.g. only be transmitted for analysis while the motor vehicle is in a fleet yard or otherwise wherein the contained air temperature effectively matches an ambient temperature. A time elapsed is calculated from a first data sample within a defined sampling period, and a statistical model is applied for at least the data samples corresponding to inflation pressure with respect to the time elapsed. A tire slow leak event is ascertained based on an evaluated amount of decrease in the inflation pressure from the statistical model, and an output signal is selectively generated corresponding to the ascertained slow leak event.

### FIELD OF THE DISCLOSURE

The present disclosure relates generally to quantifying performance aspects of tires on wheeled motor vehicles. More particularly, systems, methods, and related algorithms as disclosed herein relate to the detection of air pressure events such as slow leaks for tires of wheeled motor vehicles including but not limited to motorcycles, consumer vehicles (e.g., passenger and light truck), commercial and off-road (OTR) vehicles.

### BACKGROUND

Undetected internal air pressure leaks are critical for the optimal performance of any tire in the market. This is true for the owners of individual motor vehicles, but even more significant for the owners and administrators of heavy equipment and transportation fleets which are understandably concerned with the loss of air in their tires due to safety, performance, and environmental issues, etc.

Air leaks can introduce different challenges for companies that operate under a tight schedule. Many of these issues could range from downtime, potential delays in deliveries, and sometimes even serious damage to expensive equipment. There are many conventional solutions in the market that include a variety of vehicle monitoring systems, including for example the ability to inform users of operational information such as vehicle speed, vehicle load, vehicle longitude, and latitude coordinates. However, the conventional solutions fail to specifically and accurately address the issue of air pressure leaks from each wheel position on a motor vehicle.

For example, it is conventionally known to monitor the operating pressure history of a tire as obtained from a Tire Pressure Monitoring System (TPMS), and further calculate an amount of reduction in the inner pressure of each tire by comparative analysis between each of the tires attached to the same motor vehicle to detect a slow leakage. In general, because the internal air pressure and contained air temperature may be assumed to have a proportional relationship, changes in the internal air pressure may be considered as dependent on variation of the outside (ambient) temperature and the vehicle temperature. A “corrected” inner pressure value may be ascertained due to temperature fluctuations by applying known relationships between the pressure, temperature, and volume of the object.

However, the tire temperature during a run depends at least partially on the associated operating conditions. Tire temperature measurements from a TPMS sensor during normal operation may for example vary, depending on the operating and/or environmental conditions, from a temperature approximating that of the ambient air to about 70 degrees Celsius. Temperature-compensated inner pressure can still be derived but typically with an increased amount of dispersion in the observation error even in view thereof.

When the dispersion of the inner pressure measurements is relatively large, it is difficult to properly evaluate the amount of reduction over time, and accordingly there may be frequent instances of false positive or false negative slow leak detections.

### BRIEF SUMMARY

In view of the aforementioned deficiencies in conventional systems, machine learning approaches as disclosed herein may be implemented to accurately detect slow leaks in tires using, e.g., in-yard monitoring units.

Generally stated, various embodiments of slow leak detection systems and methods as disclosed herein may implement detected operating and/or environmental conditions associated with a motor vehicle, including for example internal air pressure measurements and contained air temperature (CAT) measurements associated with a given tire. The responses may preferably be measured directly using data acquisition systems, such as for example Tire Pressure Monitoring Systems (TPMS), which may be mounted in, on, or otherwise in association with the tire. The data acquisition system may preferably transmit data, or otherwise have the associated data collected therefrom, while the motor vehicle is resident in a fleet yard, and wherein the dispersion of the internal pressure measurements is reduced.

A random forest machine learning methodology may preferably be implemented to achieve detection of slow leaks in an embodiment as disclosed herein, and more particularly to associate slow leaks happening while the respective motor vehicle is found in a monitored fleet yard environment, such that the systems and methods as disclosed herein can readily alert users of a potential slow leak happening in their vehicles and intervene to bring the vehicle tires up to specifications and deliver optimal performance.

An exemplary embodiment of a tire monitoring method as disclosed herein includes collecting, via at least one data acquisition device mounted onboard a motor vehicle having a plurality of tires, data samples corresponding to at least inflation pressure for at least one of the plurality of tires. A time elapsed may be calculated from a first data sample within a defined sampling period, and a statistical model may be applied for at least the data samples corresponding to inflation pressure with respect to the time elapsed. A slow leak event may be ascertained based on an evaluated amount of decrease in the inflation pressure from the statistical model, wherein an output signal may be selectively generated corresponding to the ascertained slow leak event for the at least one of the plurality of tires.

In one exemplary aspect according to the above-referenced embodiment, the statistical model may require at least a first threshold value of data samples within the defined sampling period, and the time elapsed from the first data sample must exceed a second threshold value.

In another exemplary aspect according to the above-referenced embodiment, the data samples are only collected for the statistical model when a speed of the motor vehicle is determined to have been zero for a third threshold value of time.

In another exemplary aspect according to the above-referenced embodiment, the data samples are only collected while the data acquisition device is within range of one or more data collection units in a fleet yard monitoring system.

The above-referenced embodiment may further include collecting, via the at least one data acquisition device mounted onboard a motor vehicle having a plurality of tires, contained air temperatures associated with the data samples corresponding to the at least inflation pressure for the at least one of the plurality of tires. For example, a temperature-compensated inflation pressure value may be generated for each of the data samples, wherein the statistical model implements the temperature-compensated inflation pressure values for ascertaining the slow leak events. In another example, it may be determined whether to selectively generate the output signal corresponding to an ascertained slow leak event based at least in part on the associated contained air temperatures. In another example, it may be determined whether to selectively generate the output signal corresponding to an ascertained slow leak event based on an hourly change rate in the associated contained air temperatures with respect to a threshold value.

In another exemplary aspect according to the above-referenced embodiment, the slow leak event may be ascertained further in view of a median value of a metric corresponding to the evaluated amount of decrease in the inflation pressure, with respect to a second defined sampling period.

In another exemplary aspect according to the above-referenced embodiment, the statistical model may comprise a linear regression model with a target variable comprising the inflation pressure and a description variable comprising the elapsed time. In addition, or alternatively, the statistical model may comprise a random forest model.

In another embodiment as disclosed herein, a tire monitoring system comprises at least one data acquisition device mounted onboard a motor vehicle having a plurality of tires and configured to collect data samples corresponding to at least inflation pressure for at least one of the plurality of tires, and at least one data collection unit configured to receive the collected data samples from the onboard data acquisition device, for example while the motor vehicle is in-yard and not operating on the road. A processing unit is linked to the at least one data collection unit and configured to direct the performance of operations according to the above-referenced method embodiment and optionally one or more of the associated exemplary aspects above.

Unless otherwise defined, all technical and scientific terms used herein have the same meaning as commonly understood by one of ordinary skill in the art to which this invention belongs. An invention as disclosed herein may be embodied in other specific forms without departing from the spirit or essential attributes thereof, and it is therefore desired that the various embodiments be considered in all aspects as illustrative and not restrictive. Any headings utilized in the description are for convenience only and no legal or limiting effect. Numerous objects, features and advantages of the embodiments set forth herein will be readily apparent to those skilled in the art upon reading of the following disclosure when taken in conjunction with the accompanying drawings.

### BRIEF DESCRIPTION OF THE SEVERAL VIEWS OF THE DRAWINGS

Hereinafter, embodiments of the invention are illustrated in more detail with reference to the drawings.

FIG. 1 is a block diagram representing an embodiment of a tire monitoring system as disclosed herein.

FIGS. 2a and 2b are graphical diagrams representing normal conditions and the presence of slow leak conditions, respectively, based on collected time-series data.

FIGS. 3-7 are graphical diagrams representing exemplary pattern recognition steps in accordance with an embodiment of a system/method as disclosed herein.

FIG. 8 is a graphical diagram representing an exemplary slope of a line for best fit of internal air pressure measurements over time.

FIGS. 9 and 10 are graphical diagrams representing exemplary defined sampling periods according to the present disclosure.

FIGS. 11a to 11d are graphical diagrams representing exemplary time-series data associated with true positive event detection, false negative event detection, false positive event detection, and true negative event detection, respectively.

FIG. 12 is a flowchart representing an embodiment of a tire monitoring method as disclosed herein.

### DETAILED DESCRIPTION

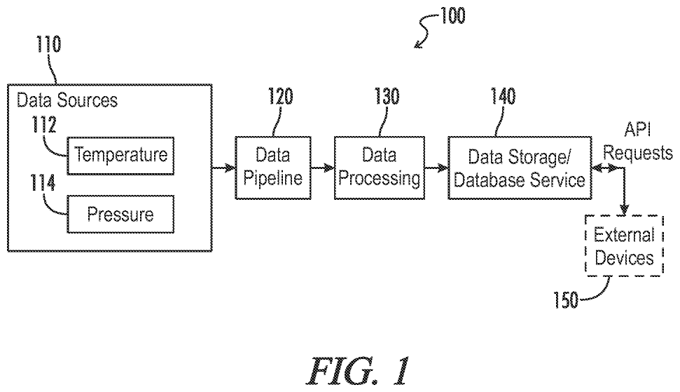

Referring generally to FIGS. 1-12, various exemplary embodiments of an invention may now be described in detail. Where the various figures may describe embodiments sharing various common elements and features with other embodiments, similar elements and features are given the same reference numerals and redundant description thereof may be omitted below.

Referring initially to FIG. 1, an exemplary embodiment of the system 100 includes a data acquisition device 110 that is onboard a vehicle and configured to at least obtain data and transmit said data to one or more downstream computing devices (e.g., a remote server) to perform relevant computations as disclosed herein. The data acquisition device may be a standalone sensor unit appropriately configured to collect raw measurement signals, such as for example signals corresponding to a tire's contained air temperature 112 and/or internal air pressure 114, and to continuously or selectively transmit such signals. The data acquisition device may include an onboard computing device in communication with one or more distributed sensors and which is portable or otherwise modular as part of a distributed vehicle data collection and control system, or otherwise may be integrally provided with respect to a central vehicle data collection control system. The data acquisition device may include a processor and memory having program logic residing thereon (not shown), and in various embodiments may comprise a vehicle electronic control unit (ECU) or a component thereof, or otherwise may be discrete in nature, for example permanently or detachably provided with respect to a vehicle mount.

Generally stated, a system 100 as disclosed herein may implement numerous components distributed across one or more vehicles, for example but not necessarily associated with a fleet management entity, and further a central server network or event-driven serverless platform in functional communication with each of the vehicles motor via a communications network. Exemplary vehicle components may typically include one or more sensors such as, e.g., vehicle body accelerometers, gyroscopes, inertial measurement units (IMU), position sensors such as global positioning system (GPS) transponders, tire pressure monitoring system (TPMS) sensor transmitters and associated onboard receivers, gateway devices, or the like, as linked for example to a controller area network (CAN) bus network and providing signals thereby to local processing units. The illustrated embodiment may include for illustrative purposes, without otherwise limiting the scope of the present invention thereby, a tire-mounted TPMS sensor unit, an ambient temperature sensor, a vehicle speed sensor configured to collect for example acceleration data associated with the vehicle, and a DC power source.

One or more of the sensors as disclosed herein may be integrated or otherwise collectively located in a given modular structure as opposed to being discrete and decentralized in structure. For example, a tire-mounted TPMS sensor as referred to herein may be configured to generate output signals corresponding to each of a plurality of tire-specific conditions (e.g., inflation pressure, contained air temperature). The TPMS sensor may for example be mounted internally in the tire air cavity, slightly elevated and isolated from the metal rim so as not to be adversely influenced thereby.

Various bus interfaces, protocols, and associated networks are well known in the art for the communication between the respective data source and the local computing device, and one of skill in the art would recognize a wide range of such tools and means for implementing the same.

In various embodiments, data acquisition devices and equivalent data sources 110 as disclosed herein are not necessarily limited to vehicle-specific sensors and/or gateway devices and can also include third party entities and associated networks, program applications resident on a user computing device such as a driver interface, a fleet management interface, and any enterprise devices or other providers of raw streams of logged data as may be considered relevant for algorithms and models as disclosed herein.

Referring again to FIG. 1, a data pipeline stage 120 may be provided wherein data collected from one or more data sources 110 are transmitted to a data processing stage 130. The data processing stage 130 further interacts with a data storage stage 140, including for example one or more database services, wherein the data processing stage 130 and/or data storage stage 140 selectively interact with users of external devices 150 and/or networks via for example respective Application Program Interface (API) requests.

In an embodiment, an exemplary data pipeline stage 120 may include event-driven serverless architecture wherein one or more event hubs are configured to facilitate raw data capture from respective sources, to generate a normalized data stream therefrom, and further to copy ingested events in relevant time intervals to a data storage resource. Normalized and enhanced data streams may be further submitted for analytical processing via for example a data lake platform as known in the art. Non-limiting examples of data lakes as known in the art may include Azure Data Lake®, Kafka®, Hadoop®, and the like.

It should be noted that the embodiment represented in FIG. 1 is not limiting on the scope of a system or method as disclosed herein, and that in alternative embodiments one or more pressure loss rate models may be implemented locally at an onboard computing device (e.g., electronic control unit) rather than at a downstream computing stage. For example, models may be generated and trained over time at a server level and downloaded to an onboard computing device for local execution of one or more steps or operations as disclosed herein.

In other alternative embodiments, one or more of the various sensors 112, 114 may be configured to communicate with downstream platforms without a local vehicle-mounted device or gateway components, such as for example via cellular communication networks or via a mobile computing device (not shown) carried by a user of the vehicle.

The term “user interface” as used herein may, unless otherwise stated, include any input-output module by which a user device facilitates user interaction with respect to a processing unit, server, device, or the like as disclosed herein including, but not limited to, downloaded or otherwise resident program applications; web browsers; web portals, such as individual web pages or those collectively defining a hosted website; and the like. A user interface may further be described with respect to a personal mobile computing device in the context of buttons and display portions which may be independently arranged or otherwise interrelated with respect to, for example, a touch screen, and may further include audio and/or visual input/output functionality even without explicit user interactivity.

Vehicle and tire sensors 112, 114, etc., may in an embodiment further be provided with unique identifiers, wherein an onboard device processor can distinguish between signals provided from respective sensors on the same vehicle, and further in certain embodiments wherein a central processing unit and/or fleet maintenance supervisor client device may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/downstream data storage and implementation for calculations as disclosed herein. An onboard data acquisition device may communicate directly with the downstream processing stage 130 as shown in FIG. 1, or alternatively the driver's mobile device or truck-mounted computing device may be configured to receive and process/transmit onboard device output data to one or more downstream processing units.

Raw signals received from a particular vehicle and/or tire sensor 112, 114, etc., may be stored in onboard device memory, or an equivalent local data storage network functionally linked to the onboard device processor, for selective retrieval and transmittal via a data pipeline stage 120 as needed for calculations according to the method disclosed herein. A local or downstream “data storage network” as used herein may refer generally to individual, centralized, or distributed logical and/or physical entities configured to store data and enable selective retrieval of data therefrom, and may include for example but without limitation a memory, look-up tables, files, registers, databases, database services, and the like. In some embodiments, raw data signals from the various sensors 112, 114, etc., may be communicated substantially in real time from the vehicle to a downstream processing unit. Alternatively, particularly in view of the inherent inefficiencies in continuous data transmission of high frequency data, the data may for example be compiled, encoded, and/or summarized for more efficient (e.g., periodic time-based or alternatively defined event-based) transmission from the vehicle to the processing unit via an appropriate (e.g., cellular) communications network.

The vehicle data and/or tire data 112, 114, etc., once transmitted via a communications network to the downstream processing unit, may be stored for example in a database associated therewith and further processed or otherwise retrievable as inputs for processing via one or more algorithmic models as disclosed herein. The models may be implemented at least in part via execution by a processor, enabling selective retrieval of the vehicle data and/or tire data and further in electronic communication for the input of any additional data or algorithms from a database, lookup table, or the like that is stored in association with the processing unit.

The terms “processor” or “processing unit” or “processing stage” 130 as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

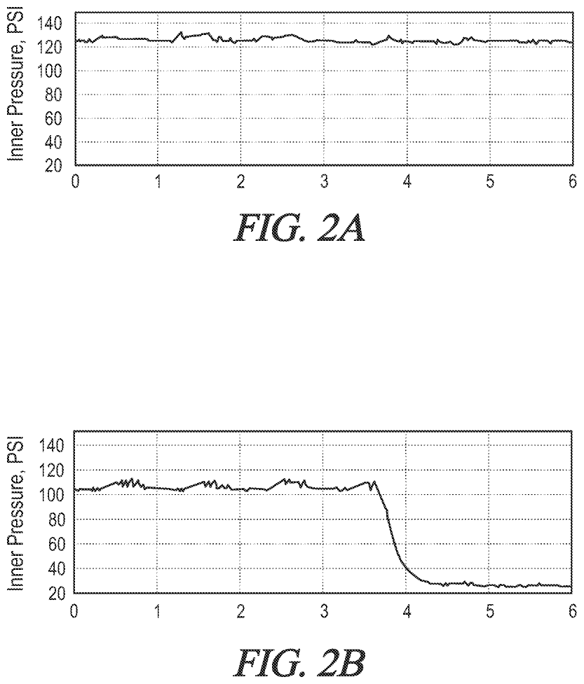

Referring hereafter to FIGS. 2-12, an exemplary method 200 may now be described for quantifying performance aspects of a motor vehicle tire, and more particularly for detecting a slow leakage phenomenon of internal air pressure at an early stage. Slow leak events, an exemplary one of which is represented in FIG. 2b, may be defined as a phenomenon in which the inner pressure decreases rapidly as compared to a natural decrease, an example of which is represented in FIG. 2a. If a motor vehicle continues to run with one or more tires having a critically low inner pressure, the risks of permanent damage to the tire are generally increased. On the other hand, if a slow leak event can be identified at an early stage, the performance of interventions such as repair and replacement of tires may reduce such risks dramatically.

The method 200 begins with collected signals at a data acquisition stage (step 210), which as previously noted may implement conventional onboard data acquisition devices such as tire pressure monitoring systems (TPMS) mounted in or on the tire, which may generate signals corresponding to one or more of contained air temperature, ambient temperature, inflation pressure, tire identifier, vertical load, speed, and the like. The data acquisition device may in some embodiments be configured to collect data as the tire is rolling on different roads and surfaces, but the system may be configured such that the only data considered in subsequent steps is collected while the motor vehicle is stopped, or otherwise resident in a fleet yard.

Otherwise stated, a data collection unit which provides tire data to the processing unit may be geographically limited in its ability to communicate with the data acquisition device and also may be fixed in location with respect to a fleet yard, such that the only time data samples are collected from a given motor vehicle is when the motor vehicle is in the fleet yard. In an embodiment, a wireless communications network associated with an in-yard monitoring unit may include one or more wireless routers which receive signals from the data acquisition device (e.g., directly from a TPMS sensor or indirectly via an onboard computing device), decodes the signals, and forwards the decoded signals for downstream processing. An exemplary data transmission frequency may be about 2.5 readings per minute while the vehicle is resident in the fleet yard.

As previously noted, conventional methods utilizing tire inflation pressure data during vehicle operation can result in false positives or false negatives due to the variability in the associated temperature compensation. It may also be appreciated that with data only being collected periodically, corresponding to times when the vehicle is in a fleet yard, the variable frequency of the readings may introduce noise into the subsequent calculations and at least potentially result in false positives or false negatives. Accordingly, data models as disclosed herein may implement various techniques to filter data and to label and recognize time-series data patterns for accurate identification of the relevant pressure loss events.

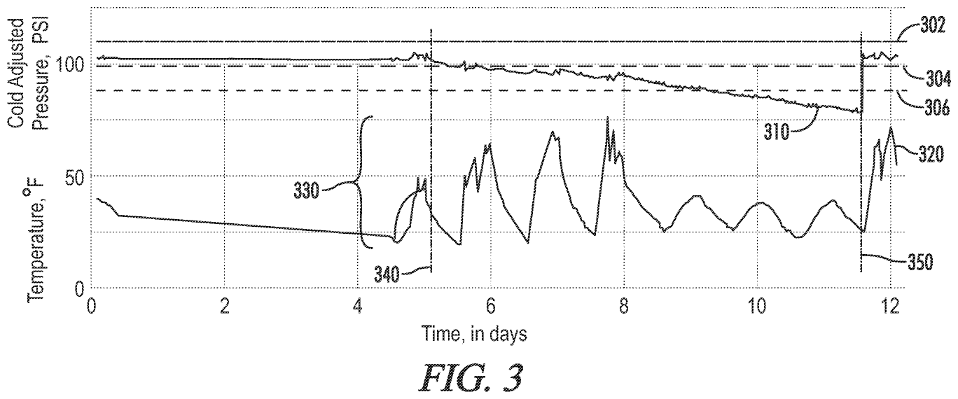

Referring next to FIG. 3, in an exemplary data set the cold inflation pressure values 310 for a given tire are shown to decline gradually from a first time 340 until a second time 350 when an apparent inflation event occurs. At the first time 340, the measured values 310 are comfortably between a recommended threshold value 302 and a warning threshold value 304. As time progresses the measured values 310 fall below the warning threshold value 304 and even a critical threshold value 306, well before the second time 350 and as an indication of a gradual decrease lasting more than a few hours, and substantially out of step with fluctuations in the associated temperature values 320. In other words, while the measured temperature values 320 continuously fluctuate within a band 330, the gradual decrease in the tire inflation pressure is demonstrably not a function of the temperature.

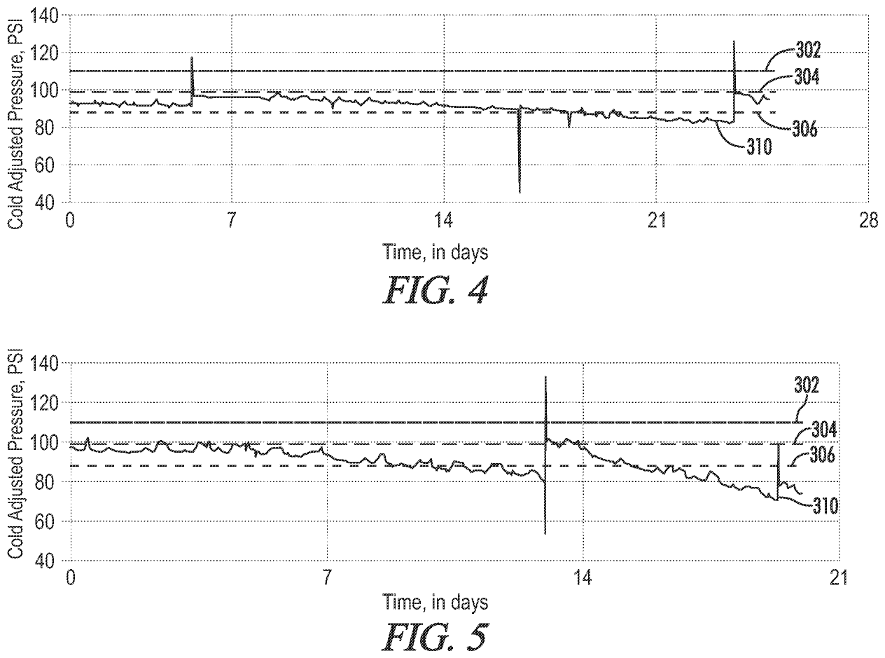

Referring next to FIG. 4, another exemplary data set illustrates another gradual multi-day decrease in inflation pressure values 310, interrupted by a downward spike and return to prevailing trend. Notwithstanding this downward spike, which may correspond to for example an inflation pressure check, the overall trend is indicative of a slow leak event as would preferably be identified by models as disclosed herein. It may be noted as well that time-series data corresponding to slow leak events are often bracketed on first and second ends by tire inflation events (as shown here), but this is not necessarily the case for all such slow leak events. As represented in FIG. 5, for example, two subsequent gradual multi-day declines in tire inflation pressure measurements 310 may preferably be labelled as two separate events.

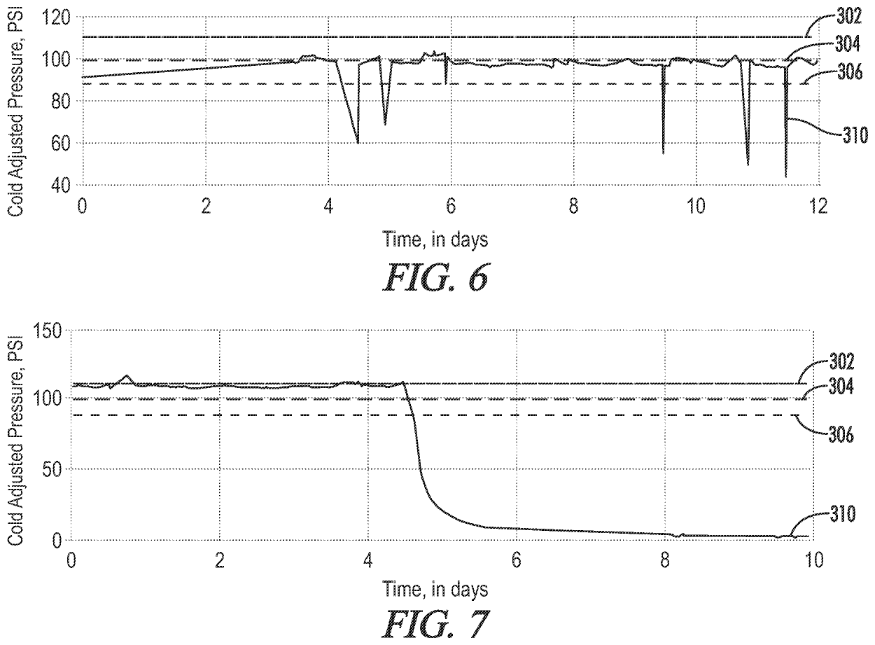

Another exemplary data set as illustrated in FIG. 6 illustrates the importance of focusing on the overall trend of inflation pressure measurements 310, rather than determining false positives for slow leak events based on intermittent downward spikes (e.g., corresponding to pressure checks). In this case, the overall trend of the pressure measurements is flat. In FIG. 7, on the other hand, a sudden (i.e., not gradual) drop in the internal pressure measurements 310 is represented without a return to trend, as may be indicative of a major failure in the tire such as a puncture from a nail or other obstruction. Such an event may be characterized in some embodiments as equivalent to a slow leak event for the purpose of generating alerts for intervention or the like, but in other embodiments a data set such as found in FIG. 7 may preferably be defined separately from slow leak events.

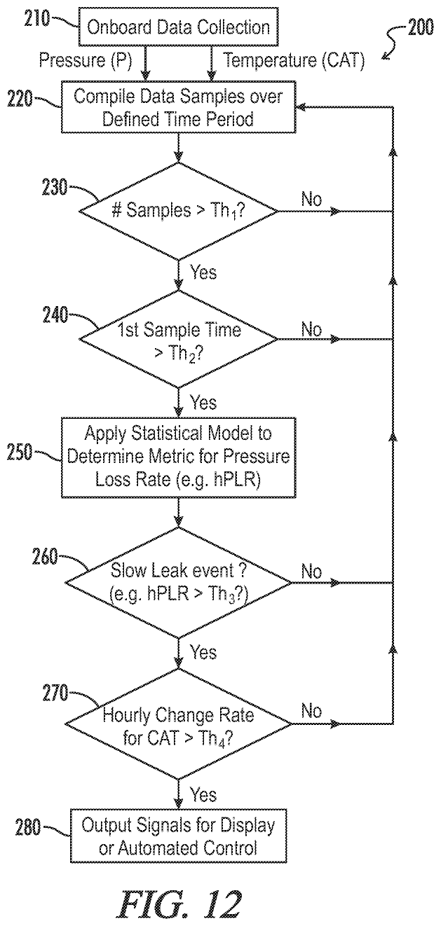

Returning to FIG. 12, the method 200 may continue by compiling data samples over a defined sampling time period (step 220). In an embodiment, this involves creating a subset of inner pressure measurements that have been collected over the previous twenty hours. Further thresholds are set to define a data acquisition gate, such that the amount of data relied upon for pressure loss rate estimation is sufficient and accordingly the results of the algorithms are less susceptible to noise. In step 230, the number of samples in the created subset is compared to a predetermined first threshold value. If the first threshold is met, in step 240 the method continues by calculating a difference between the time of a first observation in the created subset and a time of a newest observation in the created subset and comparing the difference to a predetermined second threshold value. In one example, the requisite number of samples is five and the requisite time period between the first and most recent samples is thirty minutes, but various alternative values and thresholds may be implemented within the scope of the present disclosure.

Where the first and second thresholds (or equivalents thereof) have been satisfied, the method 200 may continue by applying statistical models to determine a metric associated with pressure loss rate as disclosed herein (step 250). In the following example, an hourly pressure loss rate (hPLR) may be estimated by constructing a linear regression model with the target variable being the tire inner pressure (or temperature-compensated inner pressure as further described below) in pounds per square inch (psi) and the description variable in elapsed time, using the least squares approach:

pressure (psi)=α+β×(elapsed time)

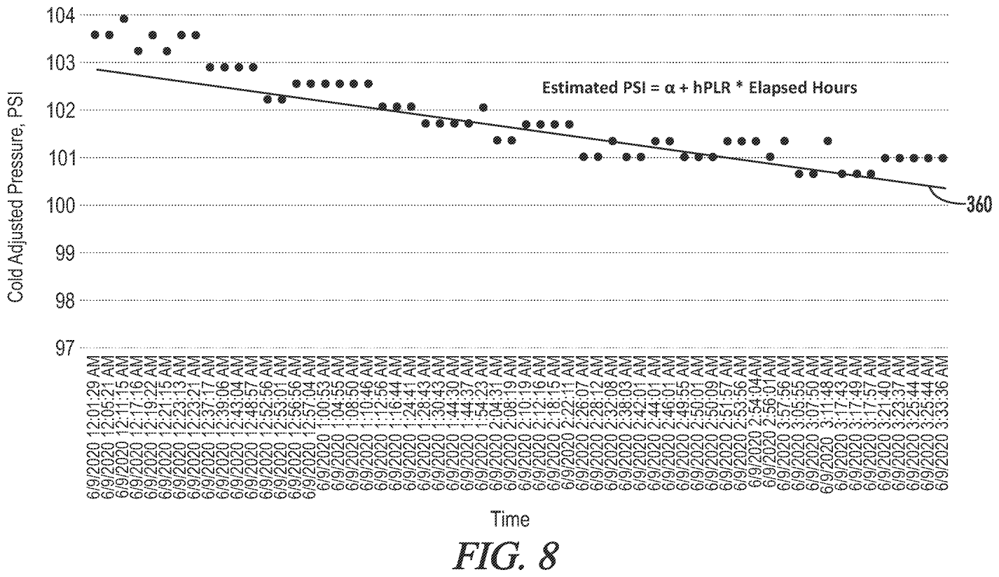

In this context, and as illustrated in FIG. 8, the regression coefficient β is estimated as the hourly pressure loss rate (hPLR) over the defined time window (e.g., twenty hours), whereas the pressure loss rate itself may be the slope of the line 360 of best fit for inner pressure over time, computed using the linear regression model.

In various embodiments (not shown in FIG. 2), “corrected” inner pressure values (i.e., temperature compensation) may further be utilized in the above-referenced equation and as obtained for example by applying the ideal gas law to the sampled temperature and inner pressure values.

In step 260, the method 200 continues by comparing the estimated metric (e.g., hPLR) to a predetermined third threshold value, wherein if the threshold value is exceeded a slow leak event is determined.

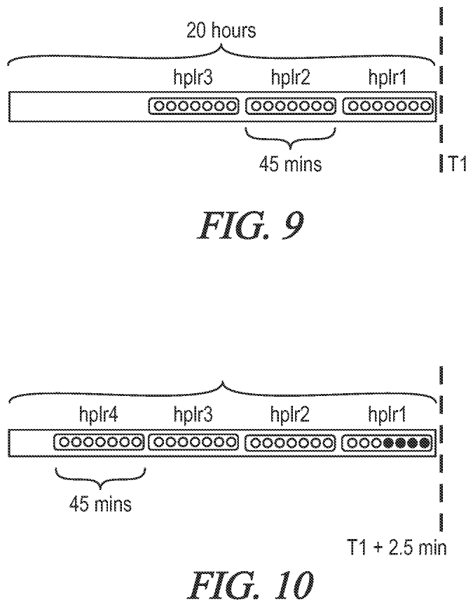

In an embodiment as represented in FIG. 9, individual hPLR estimations are determined for each new measurement over the defined sampling period, looking back from a current time Ti. For each new estimation, a median hPLR is determined for each block of data (e.g., 45 minutes), defining in this example three different median values hplr1, hplr2, hplr3 for three successive 45-minute blocks. If the median hPLR value for a respective block of individual estimations is determined to, e.g., be less than −1.0 psi, a slow leak event may be determined for the corresponding tire. As further illustrated in FIG. 10, with each new hPLR value that is estimated the individual historical hPLR values may be re-grouped, as long as they fall within the defined sampling window (e.g., 20 hours), and median values are calculated and once again compared to the threshold (e.g., −1.0 psi).

The method 200 may optionally include a step 270 wherein a determined slow leak event may be suppressed or dismissed based on a further determination that a temperature-based metric, such as for example hourly change rate of the temperature values corresponding to the same inner pressure values that were the basis of the slow leak event determination, exceeds a predetermined fourth threshold value. As one example, an hourly temperature change rate (hTCR) in excess of twenty degrees Fahrenheit over the corresponding period of time may result in suppression or dismissal of a determined slow leak event.

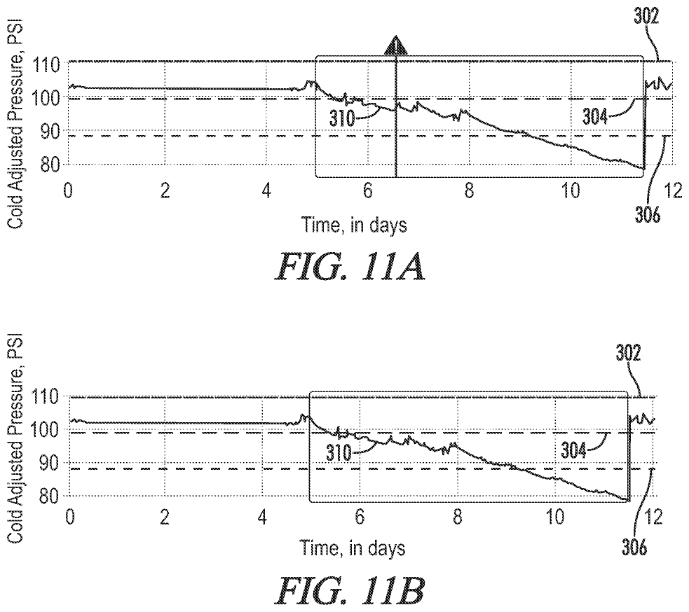

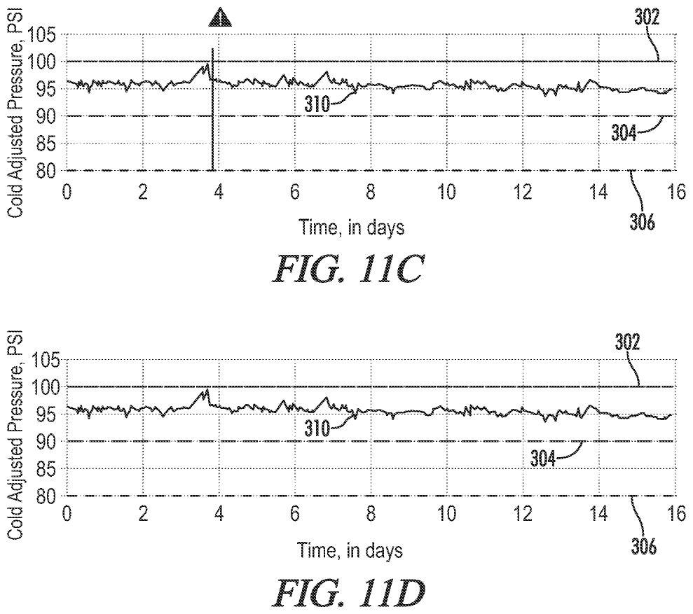

Referring next to FIGS. 11a-11d, sample slow leak events and non-events are illustrated from a random forest approach. The highlighted portion of FIG. 11a represents a “true positive” (TP) system output which corresponds with a properly detected actual slow leak event. The highlighted portion of FIG. 11b represents a “false negative” (FN) system output which corresponds with an undetected actual slow leak event. The highlighted portion (arrow) in FIG. 11c represents a “false positive” (FP) system output which corresponds with an improperly detected slow leak event, wherein a downward slope from a brief upward spike was correlated with a slow leak event absent a meaningful change in the tire inner pressure trend. FIG. 11d represents a “true negative” (TN) system output which corresponds with a properly detected non-event.

It may be understood that the various threshold values provided for the method 200 herein are merely exemplary, as such values may be optimized over time for a given application.

An evaluation methodology for the above-referenced statistical model may be treated as a classification problem in the context of machine learning, which in the following example may be to maximize the precision, recall, and accuracy of the evaluations over time. “Precision” in this context may for example relate to the probability that, if an alert is triggered, the alert corresponds to a real condition, and may be quantified as {Precision=TP/(TP+FP)}. “Recall” in this context may for example relate to the probability that, if a real slow leak condition is present, a corresponding alert is triggered, and may be quantified as {Recall=TP/(TP+FN)}. “Accuracy” in this context may take both precision and recall into account to illustrate how often alerts trigger correctly. For example, if a single FP alert is triggered for one (1) wheel position on one motor vehicle, precision and accuracy are equal to 0. If that same single FP alert occurs in a population of one hundred (100) wheel positions, precision is still equal to 0 but accuracy is 99% (because there were 99 TN readings). This can be quantified as {Accuracy=(TP+TN)/Population}. As the precision and recall metrics are effectively trade-offs between each other, an additional score (F1) may be implemented to balance the precision and recall metrics by taking an average thereof, such that {F1=(Precision+Recall)/2}. To calculate the index, it is necessary to define correct and incorrect answers in the classification problem. In an exemplary evaluation, the answer was correct for a “slow leak” sample if an alert was issued even once in six days of an extracted partial time series, and the answer was correct for a “normal” tire sample if no alert was issued in the partial time series.

In various embodiments, the method 200 may further involve generating output signals (step 280) corresponding to detected slow leak events, such as for example in the form of alerts or messages to a user interface or display unit. The output signals may be programmatically generated in response to detected slow leak events. The output signals may be responsively generated with respect to received user requests, such as for example by logging events over time and delivering a report in batch format. The output signals may further be generated to automatically trigger or otherwise facilitate a control response or intervention with respect to motor vehicle control or fleet management controls.

In an embodiment, the slow leak event outputs from the system 100 and method 200 may be further implemented to predict future timing of tire intervention such as suggested or required inflation or replacement scheduling.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

Whereas certain preferred embodiments of the present invention may typically be described herein with respect to methods executed by or on behalf of fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire internal air pressure loss and potential disabling, replacement, or intervention.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this invention except as set forth in the following claims.

1-13. (canceled)

14. A tire monitoring method, comprising:
collecting, via at least one data acquisition device mounted onboard a motor vehicle having a plurality of tires, data samples corresponding to at least inflation pressure for at least one of the plurality of tires;
calculating a time elapsed from a first data sample within a defined sampling period;
applying a statistical model for at least the data samples corresponding to inflation pressure with respect to the time elapsed;
ascertaining a slow leak event based on an evaluated amount of decrease in the inflation pressure from the statistical model; and
selectively generating an output signal corresponding to the ascertained slow leak event for the at least one of the plurality of tires.

15. The tire monitoring method of claim 14, wherein the statistical model requires at least a first threshold value of data samples within the defined sampling period, and the time elapsed from the first data sample must exceed a second threshold value.

16. The tire monitoring method of claim 15, wherein the data samples are only collected for the statistical model when a speed of the motor vehicle is determined to have been zero for a third threshold value of time.

17. The tire monitoring method of claim 15, wherein the data samples are only collected while the data acquisition device is within range of one or more data collection units in a fleet yard monitoring system.

18. The tire monitoring method of claim 17, further comprising:
collecting, via the at least one data acquisition device mounted onboard a motor vehicle having a plurality of tires, contained air temperatures associated with the data samples corresponding to the at least inflation pressure for the at least one of the plurality of tires; and
generating a temperature-compensated inflation pressure value for each of the data samples,
wherein the statistical model implements the temperature-compensated inflation pressure values for ascertaining the slow leak events.

19. The tire monitoring method of claim 17, further comprising:
collecting, via the at least one data acquisition device mounted onboard a motor vehicle having a plurality of tires, contained air temperatures associated with the data samples corresponding to the at least inflation pressure for the at least one of the plurality of tires; and
determining whether to selectively generate the output signal corresponding to an ascertained slow leak event based at least in part on the associated contained air temperatures.

20. The tire monitoring method of claim 19, comprising determining whether to selectively generate the output signal corresponding to an ascertained slow leak event based on an hourly change rate in the associated contained air temperatures with respect to a threshold value.

21. The tire monitoring method of claim 14, wherein the slow leak event is ascertained further in view of a median value of a metric corresponding to the evaluated amount of decrease in the inflation pressure, with respect to a second defined sampling period.

22. The tire monitoring method of claim 14, wherein the statistical model comprises a linear regression model with a target variable comprising the inflation pressure and a description variable comprising the elapsed time.

23. The tire monitoring method of claim 14, wherein the statistical model comprises a random forest model.

24. A tire monitoring system comprising:
at least one data acquisition device mounted onboard a motor vehicle having a plurality of tires, and configured to collect data samples corresponding to at least inflation pressure for at least one of the plurality of tires;
at least one data collection unit configured to receive the collected data samples from the onboard data acquisition device; and
a processing unit linked to the at least one data collection unit and configured to
calculate a time elapsed from a first data sample within a defined sampling period,
apply a statistical model for at least the data samples corresponding to inflation pressure with respect to the time elapsed,
ascertain a slow leak event based on an evaluated amount of decrease in the inflation pressure from the statistical model, and
selectively generate an output signal corresponding to the ascertained slow leak event for the at least one of the plurality of tires.

25. The tire monitoring system of claim 24, wherein the statistical model requires at least a first threshold value of data samples within the defined sampling period, and the time elapsed from the first data sample must exceed a second threshold value.

26. The tire monitoring system of claim 25, wherein the data samples are only collected for the statistical model when a speed of the motor vehicle is determined to have been zero for a third threshold value of time.

27. The tire monitoring system of claim 25, wherein the data samples are only collected while the data acquisition device is within range of the one or more data collection units located in a fleet yard monitoring area.

28. The tire monitoring system of claim 27, wherein:
the at least one data acquisition device is further configured to collect contained air temperatures associated with the data samples corresponding to the at least inflation pressure for the at least one of the plurality of tires; and
the processing unit is configured to generate a temperature-compensated inflation pressure value for each of the data samples,
wherein the statistical model implements the temperature-compensated inflation pressure values for ascertaining the slow leak events.

29. The tire monitoring system of claim 27, wherein:
the at least one data acquisition device is further configured to collect contained air temperatures associated with the data samples corresponding to the at least inflation pressure for the at least one of the plurality of tires; and
the processing unit is configured to determine whether to selectively generate an output signal corresponding to an ascertained slow leak event based on the associated contained air temperatures.

30. The tire monitoring system of claim 29, wherein the processing unit is configured to determine whether to selectively generate the output signal corresponding to an ascertained slow leak event based on an hourly change rate in the associated contained air temperatures with respect to a threshold value.

31. The tire monitoring system of claim 24, wherein the slow leak event is ascertained further in view of a median value of a metric corresponding to the evaluated amount of decrease in the inflation pressure, with respect to a second defined sampling period.

32. The tire monitoring system of claim 24, wherein the statistical model comprises a linear regression model with a target variable comprising the inflation pressure and a description variable comprising the elapsed time.

33. The tire monitoring system of claim 24, wherein the statistical model comprises a random forest model.
